(19) United States
(12) Patent Application Publication
(10) Pub. No.: US 2014/0149395 A1
(43) Pub. Date: May 29, 2014

(54) INFORMATION PROCESSING APPARATUS AND INFORMATION PROCESSING METHOD

(71) Applicant: Sony Corporation, Minato-ku (JP)

(72) Inventors: Hitoshi NAKAMURA, Tokyo (JP); Yasuaki YAMAGISHI, Kanagawa (JP)

(73) Assignee: Sony Corporation, Minato-ku (JP)

(21) Appl. No.: 14/081,343

(22) Filed: Nov. 15, 2013

Related U.S. Application Data
(60) Provisional application No. 61/729,510, filed on Nov. 23, 2012.

(51) Int. Cl. G06F 17/30

(52) U.S. Cl. CPC G06F 17/30554
USPC 707/722

(57) ABSTRACT

An information processing apparatus includes: a content management block managing first content which may be viewed on a content reproduction apparatus for reproducing content; a database block generating reference data by relating, with first signature data indicative of a feature of the first content extracted therefrom, rights management information about the first signature data and a content identifier indicative of the first content from which the first signature data was extracted and put the generated reference data into a database; and an identification block identifying, in response to a query which is transmitted from the content reproduction apparatus and is including second signature data indicative of a feature of second content extracted from the second content being viewed by a user of the content reproduction apparatus, the content by referencing the reference data stored in the database block, thereby returning a response indicative of a result of the identification.

### CROSS-REFERENCE TO RELATED APPLICATION

This application claims the benefit of priority of Provisional Application Ser. No. 61/729,510, filed Nov. 23, 2012, the entire contents of which is incorporated herein by reference.

### BACKGROUND

The disclosure relates to an information processing apparatus and an information processing method and, more particularly, to an information processing apparatus and an information processing method which are configured to execute an application program in coordination with the reproduction of content such as a television program.

For example, assume that, for viewers of a TV (television) program, information (casts, plots, previews, and so on) associated with a TV program being broadcast (hereafter referred to simply as a program) and information (news, weather forecast, traffic information, and so on) not directly associated with a program but beneficial to viewers of programs be displayed on the screen.

In order to realize the configuration described above, commands for acquiring and activating a dedicated application program (hereafter referred to as an application) may be transmitted to the television receiver or the like in coordination with the progression of a program. Actually, in Japan and European countries for example, commands and applications are transmitted by use of a band for data broadcasting in a television broadcast signal to realize the above-mentioned configuration (refer to Japanese Patent Laid-open No. 2006-50237 for example).

On the other hand, in the U.S., no band is prepared in a television broadcast signal for data broadcasting and no alternative method has been established, so that the execution of application in coordination with the progression of programs has not been realized.

It should be noted that, in the U.S., more households view programs via CATV (Cable Television) and IPTV (Internet Protocol television), for example, than those viewing programs by directly receiving television broadcast waves at the television receivers. With CATV and IPTV, only program video and audio signals may sometimes be extracted from television broadcast signals for distribution, so that, even if a data broadcasting band is arranged in television broadcast signals in the U.S., there is no guarantee that a data broadcast signal including data associated with an application is transmitted up to a reception apparatus.

Further, in viewing content such as a recorded program, video works reproduced from package media including DVD, BD, and the like, and moving images downloaded from the Internet, in addition to programs being broadcast, there have been demands for executing applications in coordinated with these items of content.

In order to satisfy these demands, the content being viewed must be recognized. One of the recognition techniques is ACR (Automatic Content Recognition), on the basis of which an ACR service is available (refer to Japanese Patent Laid-open No. 2012-168801 for example).

The ACR service is realized by an ACR client and an ACR server. The ACR client mounted on a television receiver or the like extracts signature data (watermark, finger print, and the like) from the content being viewed and transmits the extracted signature data to the ACR server to request the ACR server for the identification of the content. By comparing the received signature data with the signature data of content registered in a database beforehand, the ACR server identifies the content being viewed on the television receiver or the like. In addition, the ACR server returns metadata associated with the identified content and an application to be executed in coordinated with the content (hereafter referred to as a coordinated application) to the ACR client as an ACR response.

Receiving the above-mentioned response, the ACR client acquires a coordinated application from a predetermined server and executes the acquired coordinated application.

### SUMMARY

It should be noted that, in realizing the ACR service mentioned above, it is necessary to operate this service by honoring the right of each of the copyright owners of content and coordinated applications corresponding thereto. For the content such as TV broadcast programs and package media, the schemes for copyright protection are specified.

However, for the content associated with the ACR service and the coordinated applications associated thereto, no method of forcibly protecting the copyrights thereof has not been established. In addition, the copyright owners of content and those of the coordinated applications associated with the content may be different from each other; therefore, ACR services in which a coordinated application is activated in a form not intended by the copyright owner of the content, for example, are appearing these days. It therefore urgent to provide a scheme for forcibly protecting the copyright of the content in the market and the copyrights of the coordinated applications associated thereto and the operation rules of such a scheme.

Content copyright owners insisting the copyrights of not only content but also signature data extracted therefrom are emerging. In this case, the extraction and use of signature data from content without permission of the copyright owner of the content may infringe the right of the content copyright owner.

Therefore, the present disclosure has been made in view of these circumstances and aims to realize ACR services without infringing the rights of copyright owners of content and coordinated applications associated therewith.

An information processing apparatus according to a first mode of the present disclosure includes a content management block configured to manage first content which may be viewed on a content reproduction apparatus side for reproducing content; a database block configured to generate reference data by relating, with first signature data indicative of a feature of the first content extracted from the first content, rights management information about the first signature data and a content identifier indicative of the first content from which the first signature data was extracted and put the generated reference data into a database; and an identification block configured, in response to a query which is transmitted from the content reproduction apparatus side and is including second signature data indicative of a feature of second content extracted from the second content being viewed by a user of the content reproduction apparatus, to identify the content by referencing the reference data stored in the database block, thereby returning a response indicative of a result of the identification.

The first signature data of the reference data is encrypted. The database block can decrypt the encrypted first signature data after authentication with the content management block.

The rights management information associated with the first signature data may include an item for selecting an existing rights management scheme for the first signature data.

The rights management information associated with the first signature data may further include an item for setting a rights management scheme for the first signature data as desired.

An information processing method according to the first mode of the present disclosure is an information processing method for an information processing apparatus. The information processing method includes: causing the information processing apparatus to generate reference data by relating, with first signature data indicative of a feature of first content extracted from the first content which may be viewed on a content reproduction apparatus side for reproducing content, rights management information about the first signature data and a content identifier indicative of the first content from which the first signature data was extracted, and put the generated reference data into a database; and causing the information processing apparatus to identify the content by referencing the reference data stored in the database in response to a query which is transmitted from the content reproduction apparatus side and is including second signature data indicative of a feature of second content extracted from the second content being viewed by a user of the content reproduction apparatus, thereby returning a response indicative of a result of the identification.

In the first mode of the present disclosure, reference data is generated by relating, with first signature data indicative of a feature of the first content extracted from the first content which may be viewed on a content reproduction apparatus side for reproducing content, rights management information about the first signature data and a content identifier indicative of the first content from which the first signature data was extracted and the generated reference data is put into a database. In addition, the content is identified by referencing the reference data stored in the database in response to a query which is transmitted from the content reproduction apparatus side and is including second signature data indicative of a feature of second content extracted from the second content being viewed by a user of the content reproduction apparatus, thereby returning a response indicative of a result of the identification.

A first information processing apparatus according to a second mode of the present disclosure includes a content management block configured to manage first content which may be viewed on a content reproduction apparatus side for reproducing content; a database block configured to generate reference data by relating, with first signature data indicative of a feature of the first content extracted from the first content, a content identifier indicative of the first content from which the first signature data was extracted, an application identifier indicative of an application to be executed on the content reproduction apparatus side in coordination with the progression of the first content if the first content is being viewed on the content reproduction apparatus side, and rendering control information for controlling rendering of the application, and put the generated reference data into a database; and an identification block configured, in response to a query which is transmitted from the content reproduction apparatus side and is including second signature data indicative of a feature of second content extracted from the second content being viewed by a user of the content reproduction apparatus, to identify the content by referencing the reference data stored in the database block, thereby returning a response indicative of a result of the identification.

The rendering control information may include at least one of an item for limiting a device to which a video generated by the application is outputted and an item for limiting the superimposed display of the video of the application and a video of the content.

A first information processing method according to the second mode of the present disclosure is an information processing method for an information processing apparatus. This information processing method includes: causing the information processing apparatus to generate reference data by relating, with first signature data indicative of a feature of first content extracted from the first content which may be viewed on a content reproduction apparatus side for reproducing content, a content identifier indicative of the first content from which the first signature data was extracted, an application identifier indicative of an application to be executed on the content reproduction apparatus side in coordination with the progression of the first content if the first content is being viewed on the content reproduction apparatus side, and rendering control information for controlling rendering of the application, and put the generated reference data into a database; and causing the information processing apparatus to identify the content by referencing the reference data stored in the database in response to a query which is transmitted from the content reproduction apparatus side and is including second signature data indicative of a feature of second content extracted from the second content being viewed by a user of the content reproduction apparatus, thereby returning a response indicative of a result of the identification.

A second information processing apparatus according to the second mode of the present disclosure includes a query generation block configured to extract signature data indicative of a feature of content being reproduced, generate a query including the signature data, transmit the generated query to an identification server, and receive a response returned from the identification server in accordance with the query; and an application execution block configured to acquire an application specified to be executed in coordination with the progression of the content being reproduced on the basis of an application identifier included in the received response, execute the acquired application, and, on the basis of rendering control information of the acquired application included in the response, control the rendering of the acquired application.

The application execution block can execute, on the basis of the rendering control information, at least one of the processing of limiting a device to which a video generated by the application is outputted and the processing of limiting the superimposed display of the video of the application and a video of the content.

A second information processing method according to the second mode of the present disclosure is an information processing method for an information processing apparatus. This information processing method includes: causing the information processing apparatus to extract signature data indicative of a feature of content being reproduced, generate a query including the signature data, and transmit the generated query to an identification server; causing the information processing apparatus to receive a response returned from the identification server in accordance with the query; and causing the information processing apparatus to acquire an application specified to be executed in coordination with the progression of the content being reproduced on the basis of an application identifier included in the received response, execute the acquired application, and, on the basis of rendering control information of the acquired application included in the response, control the rendering of the acquired application.

In the second mode of the present disclosure, the first information processing apparatus generates reference data by relating, with first signature data indicative of a feature of the first content extracted from the first content which may be viewed on the second information processing apparatus side for reproducing content, a content identifier indicative of the first content from which the first signature data was extracted, an application identifier indicative of an application to be executed on the second information processing apparatus side in coordination with the progression of the first content if the first content is being viewed on the second information processing apparatus side, and rendering control information for controlling the rendering of the application, puts the generated reference data into a database, and returns a response indicative of a result of the identification of the content by referencing the reference data in the database in accordance with a query including the second signature data indicative of the second content extracted from the second content being viewed by user of the second information processing apparatus, the query being transmitted from the second information processing apparatus side. On the other hand, the second information processing apparatus generates the query, transmits the generated query to the first information processing apparatus, receives the response returned from the first information processing apparatus in accordance with the query, acquires an application specified to be executed in coordination with the progression of the content being reproduced on the basis of the application identifier included in the received query, executes the acquired application, and controls the rendering of the application on the basis of the rendering control information of the application included in the response.

A first information processing apparatus according to a third mode of the present disclosure includes a content management block configured to manage first content which may be viewed on a content reproduction apparatus side for reproducing content; a database block configured to generate reference data by relating, with first signature data indicative of a feature of the first content extracted from the first content, a content identifier indicative of the first content from which the first signature data was extracted, an application identifier indicative of an application to be executed on the content reproduction apparatus side in coordination with the progression of the first content if the first content is being viewed on the content reproduction apparatus side, and rights management information about the application and put the generated reference data into a database; and an identification block configured, in response to a query which is transmitted from the content reproduction apparatus side and is including second signature data indicative of a feature of second content extracted from the second content being viewed by a user of the content reproduction apparatus, to identify the content by referencing the reference data stored in the database block, thereby returning a response indicative of a result of the identification.

The rights management information about the application may include an item for selecting an existing rights management scheme for the application and a quoted content to be quoted by the application.

The rights management information about the application may further include an item for setting, as desired, a rights management scheme for the application and quoted content to be quoted by the application.

A first information processing method according to the third mode of the present disclosure is an information processing method for an information processing apparatus. The information processing method includes: causing the information processing apparatus to generate reference data by relating, with first signature data indicative of a feature of the first content extracted from the first content which may be viewed on a content reproduction apparatus side for reproducing content, a content identifier indicative of the first content from which the first signature data was extracted, an application identifier indicative of an application to be executed on a content reproduction apparatus side in coordination with the progression of the first content if the first content is being viewed on the content reproduction apparatus side, and rights management information about the application, and put the generated reference data into a database; and causing the information processing apparatus to identify the content by referencing the reference data stored in the database in response to a query which is transmitted from the content reproduction apparatus side and is including second signature data indicative of a feature of second content extracted from the second content being viewed by a user of the content reproduction apparatus, thereby returning a response indicative of a result of the identification.

A second information processing apparatus according to the third mode of the present disclosure includes a query generation block configured to extract signature data indicative of a feature of content being reproduced, generate a query including the signature data, transmit the query to an identification server, and receive a response returned from the identification server in accordance with the query; and an application execution block configured to acquire an application specified to be executed in coordination with the progression of the content being reproduced on the basis of an application identifier included in the received response, execute the acquired application, and, on the basis of rights management information of the application included in the response, manage the application and quoted content to be quoted by the application.

The application execution block decrypts the encrypted application on the basis of the rights management information.

The application execution block manages copy processing for the application and the quoted content on the basis of the rights management information.

A second information processing method according to the third mode of the present disclosure is an information processing method for an information processing apparatus. The second information processing method includes: causing the information processing apparatus to extract signature data indicative of a feature of content being reproduced, generate a query including the signature data, and transmit the query to an identification server; causing the information processing apparatus to receive a response returned from the identification server in accordance with the query; and causing the information processing apparatus to acquire an application specified to be executed in coordination with the progression of the content being reproduced on the basis of an application identifier included in the received response, execute the acquired application, and, on the basis of rights management information of the application included in the response, manage the application and quoted content to be quoted by the application.

In the third mode of the present disclosure, the first information processing apparatus generates reference data by relating, with first signature data indicative of a feature of the first content extracted from the first content which may be viewed on the second information processing apparatus side for reproducing content, a content identifier indicative of the first content from which the first signature data was extracted, an application identifier indicative of an application to be executed on the second information processing apparatus side in coordination with the progression of the first content if the first content is being viewed on the second information processing apparatus side, and the rights management information associated with the application, puts the generated reference data into a database, and returns a response indicative of a result of the identification of the content by referencing the reference data in the database block in accordance with a query including the second signature data indicative of the second content extracted from the second content being viewed by user of the second information processing apparatus, this query being transmitted from the second information processing apparatus side. On the other hand, the second information processing apparatus generates the query, transmits the generated query to the first information processing apparatus, receives the response returned from the first information processing apparatus in accordance with the query, acquires an application specified to be executed in coordination with the progression of the content being viewed on the basis of the application identifier included in the received response, executes the acquired application, and manages the application and quoted content quoted by the application on the basis of the rights management information of the application included in the response.

According to the first mode of the present disclosure, the execution of ACR services by use of unauthorized signature data can be prevented.

According to the second mode of the present disclosure, the rendering of an application to be executed in coordination with the progression of content can be limited.

According to the third mode of the present disclosure, the rights infringement on an application to be executed in coordination with the progression of content and quoted content quoted by this application can be prevented.

### BRIEF DESCRIPTION OF THE DRAWINGS

FIG. 1 is a block diagram illustrating an exemplary configuration of an application-coordinated system practiced as an embodiment of the present disclosure;

FIG. 2 is a block diagram illustrating an exemplary configuration of an ACR server;

FIG. 3 is a block diagram illustrating an exemplary configuration of an ACR client;

FIG. 4 is a diagram illustrating a data structure of ACR reference data;

FIG. 5 is a diagram illustrating a data structure of signature data copy control information (SCM);

FIG. 6 is a diagram illustrating a data structure of coordinated application rendering information (ARM);

FIG. 7 is a diagram illustrating a data structure of coordinated application copy control information (ACM);

FIG. 8 is a diagram illustrating a data structure of an ACR query;

FIGS. 9A and 9B are diagrams illustrating data structures of an ACR response;

FIG. 10 is a flowchart indicative of an operation of the application-coordinated system;

FIG. 11 is a flowchart indicative of another operation of the application-coordinated system; and

FIG. 12 is a block diagram illustrating an exemplary configuration of a computer.

### DETAILED DESCRIPTION OF THE PREFERRED EMBODIMENT

The following describes in detail a best mode for practicing the present disclosure (hereafter referred to as an embodiment) with reference to the drawings accompanying hereto.

### [Exemplary Configuration of Application-Coordinated System]

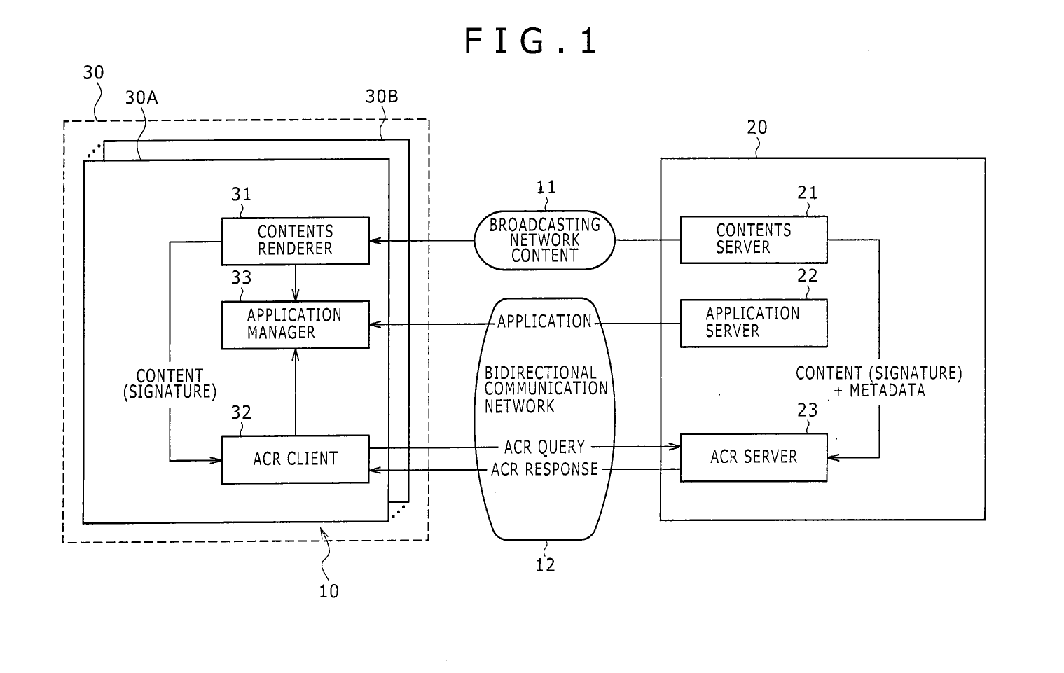

Referring to FIG. 1, there is shown an exemplary configuration of an application-coordinated system practiced as an embodiment of the present disclosure.

This application-coordinated system 10 identifies content that a user is viewing on the screen of a television receiver or the like, and executes an application in coordination with the progression of the identified content (hereafter referred to as a coordinated application).

It should be noted that content as used herein is not limited to a program being broadcast which is received by a television receiver or the like. For example, content includes all types of AV content such as a program recorded by a video recorder or the like, a video such as a movie reproduced from a package media, and a moving image downloaded via the Internet. In addition, content includes a commercial message (hereafter referred to also as a CM) inserted between programs or halfway in a program, for example.

A coordinated application may display information about a particular piece of content being viewed, namely, the metadata such as a plot and cast for example, and introduce sites for buying commercial products (cloths of the cast and goods used in the video, for example) shown in the video of the content. Further, a coordinated application may guide users to the download viewing of other pieces of content associated with the content currently being viewed. The other pieces of content guided by a coordinated application in this case will be referred to as quoted content.

For content identification, the ACR technology is used in which the content being viewed is identifying by comparing the signature data (a feature quantity) periodically extracted from the content being viewed with the signature data of the content registered in a database beforehand.

The application-coordinated system 10 is configured by a provider system 20 arranged on the side of supplying content and coordinated applications and a home network system 30 arranged at a user's home for example. The provider system 20 and the home network system 30 are interconnected via a broadcasting network 11 and a bidirectional communication network 12.

The broadcasting network 11 includes a television broadcasting network, a CATV network, and an IPTV network, for example. The bidirectional communication network 12 is indicative of an IP communication network as typified by the Internet.

The home network system 30 is configured by a primary screen device 30A and a secondary screen device 30B which are interconnected by a wireless LAN for example. The primary screen device 30A is made up of a TV receiver or the like which has a broadcast receiving tuner function. The secondary screen device 30B is made up of a portable terminal apparatus such as a mobile telephone, a smart phone, a tablet computer, or a slate PC which has no broadcast receiving tuner function. It should be noted that a portable terminal apparatus having a broadcast receiving tuner function may be used for the secondary screen device 30B.

### [Description of the Provider System 20]

The provider system 20 has a content server 21, an application server 22, and an ACR server 23.

The content server 21 broadcasts such content as a program and an CM via the broadcasting network 11. In addition, the content server 21 supplies the metadata corresponding to the broadcast content and the metadata corresponding thereto to the ACR server 23.

The above-mentioned metadata includes the signature data of content, the signature data copy control information which is the copyright information of this signature data, the identifier of a corresponding coordinated application, the coordinated-application rendering information for restricting the rendering destination of the coordinated application, and the coordinated-application copy control information which is the copyright information of the coordinated application, for example.

In what follows, signature data copy control information is abbreviated to SCM (Signature data Copy Management) information, coordinated-application rendering information to ARM (linked Application Rendering Management) information, and coordinated-application copy control information to ACM (linked Application Copy Management) information.

In response to a request from the home network system 30, the application server 22 supplies a coordinated application and data to be used by the coordinated application via the bidirectional communication network 12. At this moment, the coordinated application and the data to be used by the coordinated application may be encrypted on the basis of a DRM (Digital Rights Management: digital copyright protection) technology.

The ACR server 23 holds a database of ACR reference data in which a content identifier, an application identifier, signature data copy control information, coordinated application rendering information, and coordinated application copy control information or the like are related with the signature data extracted, at a predetermined sampling period, from each of various types of content viewable on the side of the home network system 30.

On the basis of the database of the ACR reference data, the ACR server 23 generates an ACR response in response to an ACR query transmitted from an ACR client 32 of the home network system 30 and returns the generated ACR response to the ACR client 32.

It should be noted that the content server 21, the application server 22, and the ACR server 23 which constitute the provider system 20 may be arranged at one location in a concentrated manner or at different locations in a distributed manner. In addition, the content server 21, the application server 22, and the ACR server 23 may be combined as required. Further, the content server 21, the application server 22, and the ACR server 23 may be arranged more than one each.

### [Description of the Home Network System 30]

The primary screen device 30A of the home network system 30 has a content renderer 31, the ACR client 32, and an application manager 33. It should be noted that the secondary screen device 30B also has the same component blocks as those of the primary screen device 30A.

The content renderer 31 acquires all pieces of content displayed on the display of a television receiver or the like as the primary screen device 30A and branches the obtained content, supplying the branched content to the ACR client 32. Namely, the content renderer 31 acquires and branches not only the content broadcast from the content server 21 but also the content entered via various types of input terminals (an HDMI terminal and the like) such as a television receiver and supplies the branched content to the ACR client 32.

The ACR client 32 extracts the signature data indicative of a feature of the received content at a predetermined sampling period from the content entered from the content renderer 31. It should be noted that the method of signature data extraction is the same as the extraction method for the ACR server 23 of the provider system 20 (details thereof to be described later).

In addition, the ACR client 32 generates an ACR query including the extracted signature data and transmits the generated query to the ACR server 23 of the provider system 20 via the bidirectional communication network 12. In addition, the ACR client 32 receives and holds the ACR response returned from the ACR server 23 in response to the transmitted ACR query. Further, the ACR client 32 analyzes the held ACR response and transfers the coordinated application rendering information and the coordinated application copy control information corresponding to the content being viewed to the application manager 33, thereby making the application manager 33 execute the coordinated application in coordinated with the progression of the content.

On the basis of the associated metadata, coordinated application copy control information, and coordinated application rendering information from the ACR client 32, the application manager 33 acquires and executes a coordinated application corresponding to the content being viewed from the application server 22 via the bidirectional communication network 12.

It should be noted that, in accordance with the coordinated application rendering information, the application manager 33 can specify not only the primary screen device 30A but also the secondary screen device 30B as the rendering destination of the coordinated application (or the destination on which an image by the coordinated application is displayed), details of which will be described later.

### [Exemplary Detail Configuration of the ACR Server 23]

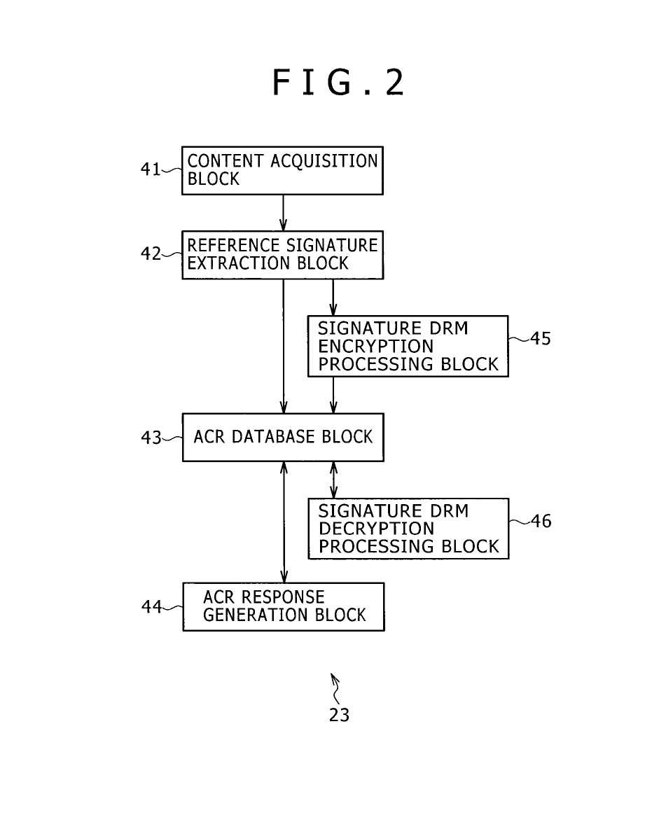

Referring to FIG. 2, there is shown an exemplary detail configuration of the ACR server 23 included in the provider system 20.

The ACR server 23 has a content acquisition block 41, a reference signature extraction block 42, an ACR database block 43, an ACR response generation block 44, a signature DRM encryption processing block 45, and a signature DRM decryption processing block 46.

The content acquisition block 41 acquires, from the content server 21, the content slated for broadcasting by the content server 21 via the broadcasting network 11 and metadata (including associated metadata, SCM information, ARM information, ACM information and so on) corresponding to the content, and supplies the acquired content to the reference signature extraction block 42. In addition, the content acquisition block 41 acquires various types of content to be viewed on the side of the home network system 30 and the corresponding metadata from the outside, and supplies the acquired content and metadata to the reference signature extraction block 42.

The reference signature extraction block 42 extracts, from the content supplied from the content acquisition block 41, the signature data indicative of the feature of this content by use of a predetermined extraction method at a predetermined sampling period and outputs the extracted signature data to the ACR database block 43. In addition, on the basis of the SCM information included in the metadata corresponding to the entered content, the reference signature extraction block 42 makes the signature DRM encryption processing block 45 encrypt the extracted signature data by use of predetermined DRM encryption processing. It should be noted that this encryption may not be executed depending upon the contents of the SCM information.

The signature data extraction scheme in the reference signature extraction block 42 may be any of existing techniques. For example, a watermark embedded in the content beforehand may extracted to provide signature data or a finger print may be computed to provide signature data.

Use of a finger print for signature data allows acquisition of the same signature data before and after the conversion in content resolution, aspect ratio, bit rate, or encoded format if any. Therefore, the accuracy of identification at the time of the content identification executed on the basis of this signature data.

It should be noted that, if there are two or more ACR servers 23, the signature data extraction schemes in the reference signature extraction blocks 42 of these ACR servers 23 may not always be the same; arbitrary extraction schemes may be respectively applied to the ACR servers 23 if required.

The ACR database block 43 generates and stores ACR reference data in which a content identifier and the like indicative of the content from which each piece of signature data was extracted are related with this signature data extracted and, if required, DRM-encrypted by the reference signature extraction block 42. Consequently, the signature data extracted from the content and DRM-encrypted is put in the database.

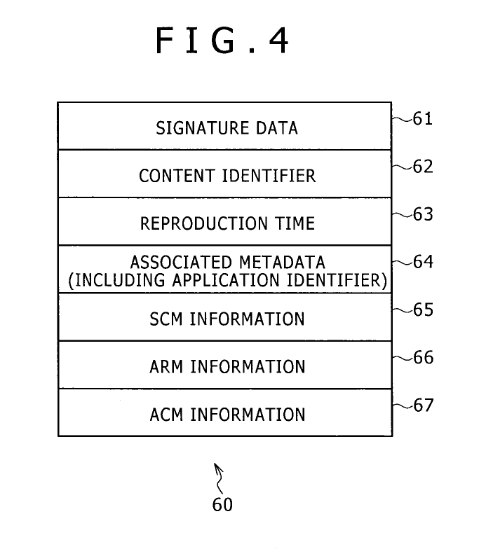

It should be noted that, if there are two or more ACR servers 23 and arbitrary signature data extraction schemes are respectively employed in the reference signature extraction blocks 42 of these ACR servers 23, then the ACR reference data in which the SCM information, the ARM information and the ACM information integrated for each piece of content are related with each piece of signature data is put in the database in each of ACR database blocks 43 of these ACR servers 23. The data structure of ACR reference data will be described later with reference to FIG. 4.

By referencing the ACR database block 43, the ACR response generation block 44 identifies the content from which the signature data included in an ACR query transmitted from the ACR client 32 was extracted. In this identification processing, if the signature data is DRM-encrypted, the ACR database block 43 makes the signature DRM decryption processing block 46 decrypt the signature data on the basis of the SCM information included in the ACR reference data and then compares the decrypted signature data with the signature data included in the ACR query.

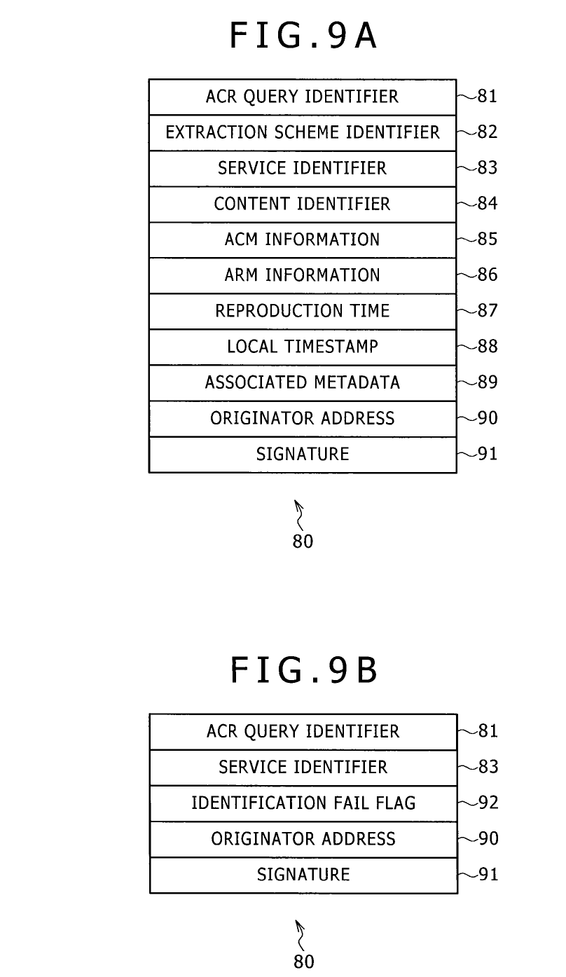

Further, the ACR response generation block 44 generates an ACR response which includes the content identifier, associated metadata, ARM information, ACM information and so on resulted from the identification processing. In addition, the ACR response generation block 44 executes matching and filtering on the associated metadata stored in the ACR response under the control of a profile matching server 24 and transmits the resultant associated metadata to the home network system 30. The data structure of an ACR response will be described later with reference to FIG. 9.

On the basis of a request from the reference signature extraction block 42, the signature DRM encryption processing block 45 encrypts the signature data extracted by the reference signature extraction block 42 by predetermined DRM encryption processing. In this encryption, necessary key exchange and so on are executed after the authentication processing with the content server 21. Consequently, the content copyright owner can be protected in both the copyrights of the content and the signature data thereof, preventing the unauthorized use of signature data bypassing the content server 21 in the execution of ACR services.

On the basis of a request from the ACR database block 43, the signature DRM decryption processing block 46 decrypts the DRM-encrypted signature data included in the ACR reference data. In this decryption, key exchange and so on necessary for DRM decryption processing are executed after the authentication processing with the content server 21 executed on the basis of the SCM information included in the ACR reference data. Consequently, the content copyright owner can be protected in both the copyrights of the content and the signature data thereof, preventing the unauthorized use of signature data bypassing the content server 21 in the execution of ACR services.

To be more specific, suppose that signature data be extracted from the broadcast content (program) without getting the permission of a broadcasting station or the like which is the copyright owner of the content, ACR reference data be generated, and an ACR service be executed by activating an unauthorized ACR server 23, for example. In this case, even if the unauthorized ACR server 23 attempts to obtain authentication with the content server 21, the content server 21 does not authenticate the unauthorized ACR as an authorized ACR server 23. Thus, the content copyright owner can detect the existence of the ACR server 23 which is executing an unauthorized ACR service by analyzing the log of the content server 21. Thus, the unauthorized ACR server 23 is excluded from the authorized ACR servers 23.

### [Exemplary Detail Configuration of the ACR Client 32]

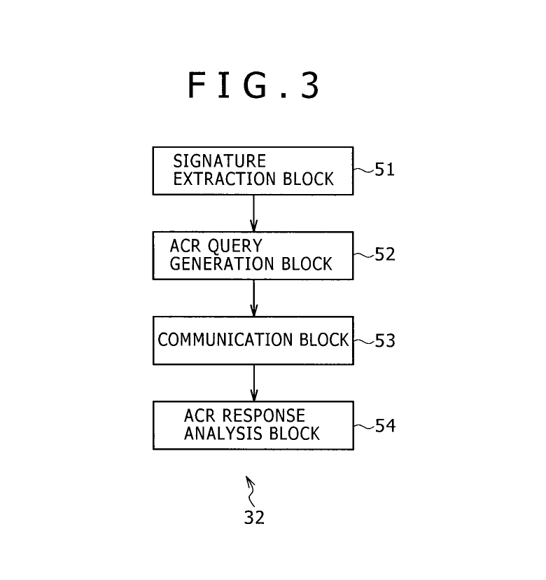

Referring to FIG. 3, there is shown an exemplary detail configuration of the ACR client 32 included in the primary screen device 30A.

The ACR client 32 has a signature extraction block 51, an ACR query generation block 52, a communication block 53, and an ACR response analysis block 54.

The signature extraction block 51 extracts, at a predetermined sampling period, the signature data indicative of the feature of the content branched by and supplied from the content renderer 31, and outputs the extracted signature data to the ACR query generation block 52. It should be noted that, for the extraction scheme for extracting the signature data by the signature extraction block 51, the same extraction scheme as that used by the reference signature extraction block 42 of the ACR server 23 used is employed.

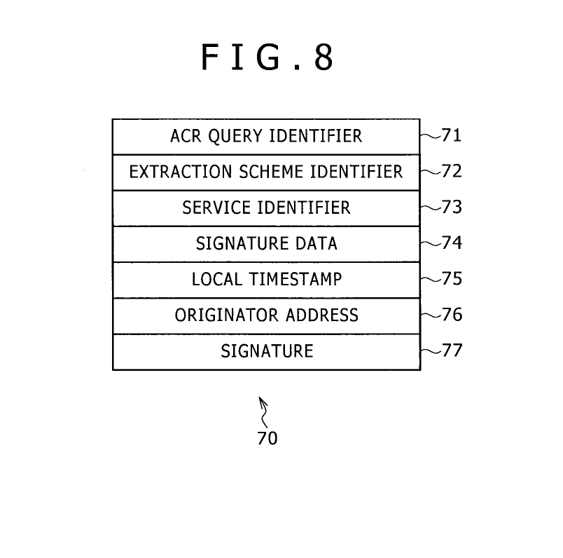

The ACR query generation block 52 generates an ACR query for requesting the ACR server 23 for the identification of the content, the ACR query including the signature data extracted by the signature extraction block 51. The data structure of the ACR query will be described later with reference to FIG. 8.

The communication block 53 transmits the ACR query generated by the ACR query generation block 52 to the ACR server 23 and receives an ACR response returned from the ACR server 23, outputting the receiving ACR response to the ACR response analysis block 54. The ACR response analysis block 54 analyzes this ACR response and notifies the application manager 33 of the associated metadata, coordinated application copy control information, coordinated application rendering information and so on included in the ACR response. On the basis of this notification, the application manager 33 acquires and executes a corresponding coordinated application.

### [Data Structure of ACR Reference Data]

Referring to FIG. 4, there is shown the data structure of ACR reference data stored in the ACR database block 43 of the ACR server 23.

In ACR reference data 60, a content identifier 62, a reproduction time 63, associated metadata 64, SCM information 65, ARM information 66, and ACM information 67 are related with each piece of signature data 61 periodically extracted from the content.

The signature data 61 is extracted from the content by the reference signature extraction block 42 and DRM-encrypted by the signature DRM encryption processing block 45 as required. The content identifier 62 is information for identifying the content from which this signature data 61 has been extracted. The reproduction time 63 is indicative of the progression timing of the content at the time when this signature data 61 has been extracted from the content indicated by the content identifier 62. The reproduction time 63 is expressed by the elapsed time from the beginning of the content.

The associated metadata 64 includes the metadata of the content indicated by the content identifier 62, the application identifier indicative of a coordinated application to be executed in coordination with the progression timing of the content indicated by the reproduction time 63 and the destination from which this coordinated application is obtained (the application server 22 in this example), and various kinds of data for use by this coordinated application in execution.

It should be noted that the associated metadata 64 may include different data from those mentioned above depending on the progression timing of the content indicated by the reproduction time 63.

SCM information 65 is indicative of whether or not the signature data 61 requires copyright protection as with the content and, if copyright protection is found required, defines the contents of proper copyright protection processing. Arrangement of this SCM information 65 allows the realization of the copyright protection for each piece of the periodically extracted signature data 61.

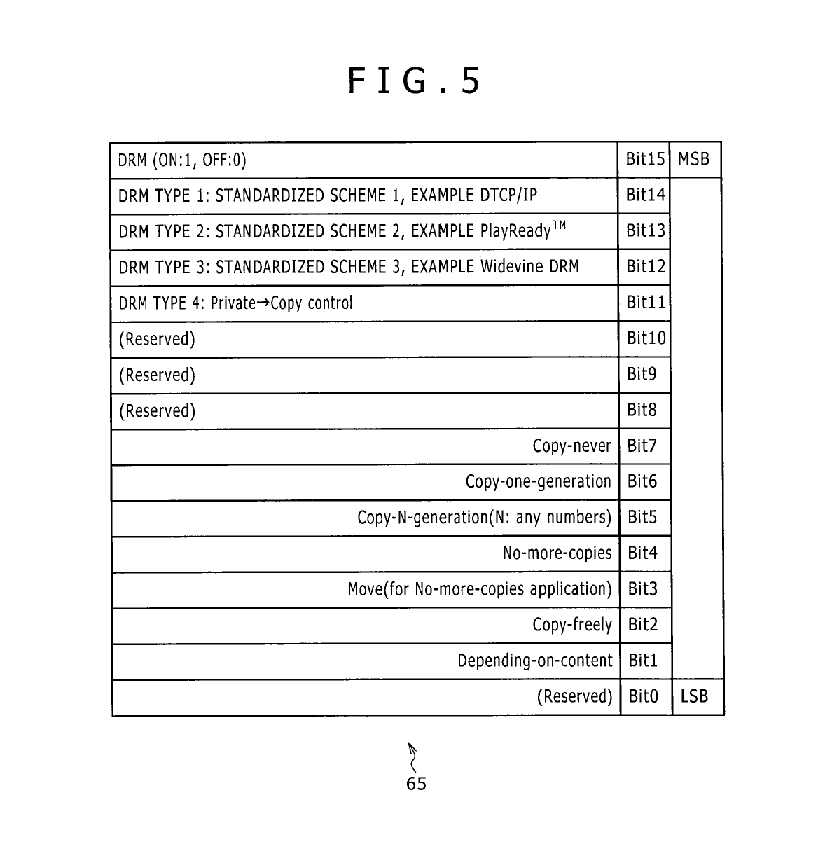

Referring to FIG. 5, there is shown an exemplary data structure of SCM information 65 defined in 16 bits.

The 16-bit SCM information 65 includes a flag (Bit 15) indicative of on/off of DRM control and, if DRM control is on, a flag (Bit 14 through Bit 11) for selection from among three schemes with DRM type standardized or from among non-standardized local schemes, in this order from MSB. In addition, if a non-standardized local scheme is selected, SCM information 65 includes a flag (Bit 7 through Bit 1) for defining the specific contents (copy prohibited, copy permitted for one generation, for example) of DRM control for signature data 61 and a reserve flags (Bit 10 through Bit 8 and Bit 0) for future extension.

For example, if, for the signature data 61 extracted from the content with DRM information set to copy prohibited, the copyright owner of this content requests the signature data 61 for executing the similar copyright operation as that of content and requests the signature data 61 to be operated by DTCP/IP which is a standardized DRM control scheme, then SCM information 65 is expressed by 1100 0000 1000 0000′b.

Referring to FIG. 4 again, ARM information 66 is information for executing a coordinated application determined to be executed in coordination with the progression of the content from which the signature data 61 has been extracted and defining the display destination (or the rendering destination) of the image of this coordinated application.

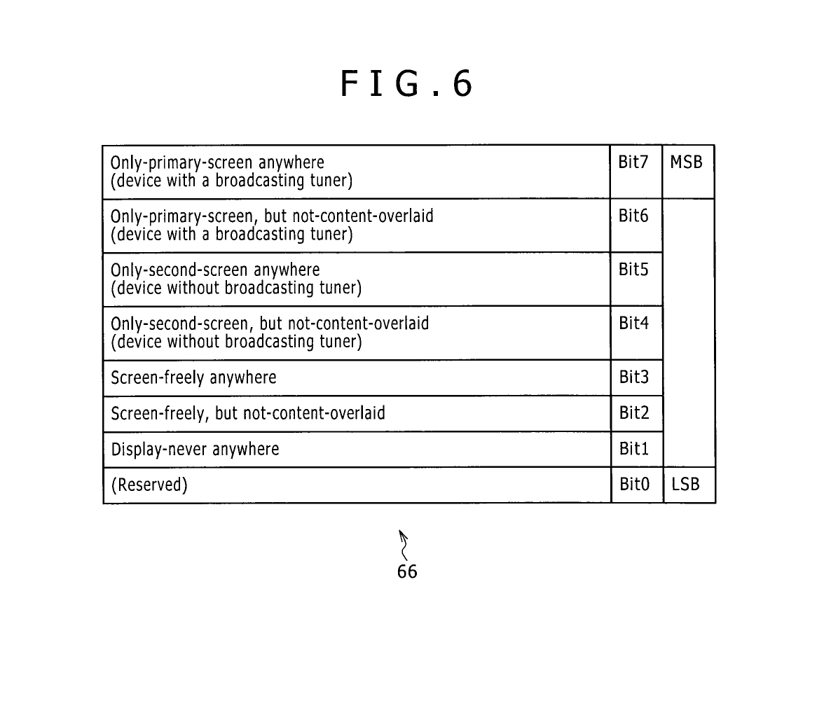

Referring to FIG. 6, there is shown an exemplary data structure obtained when ARM information 66 is defined by 8 bits.

The 8-bit ARM information 66 includes a flag (Bit 7) for permitting display anywhere on the primary screen device 30A, a flag (Bit 6) for permitting display on the primary screen device 30A but not permitting superimposed display onto content, a flag (Bit 5) for permitting display anywhere on the secondary screen device 30B, and a flag (Bit 4) for permitting display on the secondary screen device 30B but not permitting superimposed display on content, in this order from MSB. In addition, ARM information 66 includes a flag (Bit 3) for permitting display anywhere on any one of the primary screen device 30A and the secondary screen device 30B, a flag (Bit 2) for permitting display anywhere on the primary screen device 30A and the secondary screen device 30B but not permitting superimposed display on the content, and a flag (Bit 1) for prohibiting display on any device. Further, ARM information 66 includes a reserved flag (Bit 0) allocated for future extension.

For example, if, for a display relation between content and application, rendering of a coordinated application onto the primary screen device 30A is permitted but the superimposed display onto the content is not permitted as a result of the negotiation between the copyright owners of content and application, then ARM information 66 is expressed by 0100 0000′b.

Referring to FIG. 4 again, ACM information 67 is indicative of the copyright information defined by the copyright owner of a coordinated application for the coordinated application and quoted content determined to be executed in coordination with the progression of the content from which signature data 61 has been extracted.

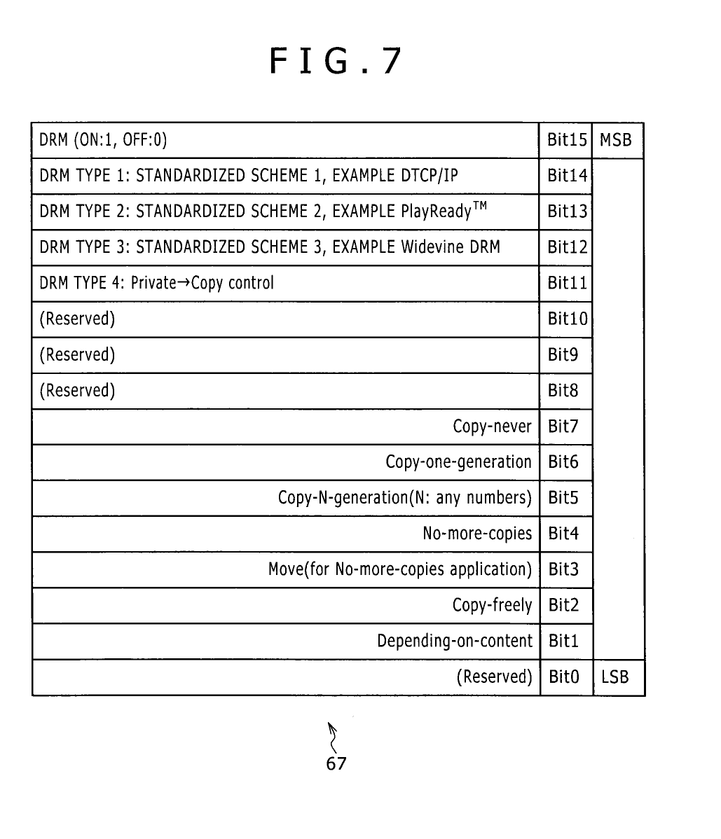

Referring to FIG. 7, there is shown an exemplary data structure obtained when ACM information 67 is defined by 16 bits.

The 16-bit ACM information 67 a flag (Bit 15) indicative of on/off of DRM control and, if DRM control is on, a flag (Bit 14 through Bit 11) for selection from among three schemes with DRM type standardized or from among non-standardized local schemes, in this order from MSB. In addition, if a non-standardized local scheme is selected, ACM information 67 includes a flag (Bit 7 through Bit 1) for defining the specific contents (copy prohibited, copy permitted for one generation, for example) and a reserve flags (Bit 10 through Bit 8 and Bit 0) for future extension.

For example, if the copyright owner of a coordinated application operates the coordinated application and quoted content by PlayReady (trademark) which is specified DRM control scheme and the free number of times copy is permitted, then ACM information 67 is expressed by 1010 0000 0000 0100′b.

### [Data Structure of ACR Query]

Referring to FIG. 8, there is shown an exemplary data structure of an ACR query which is generated in the ACR query generation block 52 of the ACR client 32.

An ACR query 70 includes an ACR query identifier 71, an extraction scheme identifier 72, a service identifier 73, signature data 74, a local timestamp 75, an originator address 76, and a signature 77.

The ACR query identifier 71 is information for uniquely identifying the ACR query 70. The extraction scheme identifier 72 is information for identifying an extraction scheme used in extracting the signature data 74. The service identifier 73 is information for selecting, from two or more ACR servers 23, an ACR server 23 which transmits an ACR query 70 and receives an ACR response.

The signature data 74 is extracted from the content in the ACR client 32. The local timestamp 75 is indicative of a timing with which the signature data 74 was extracted from the content and is expressed by a time indicated by a local system clock of the primary screen device 30A.

The originator address 76 is an address in the bidirectional communication network 12 of the ACR client 32 which originates this ACR query 70 and is used for indicating the return destination of an ACR response which is generated in the ACR server 23 in response to this ACR query 70. The signature 77 is used to prevent the tampering of this ACR query 70. It should be noted that the entire ACR query 70 may be encrypted for transmission independently of the copyright of the content.

### [Data Structure of ACR Response]

Referring to FIG. 9, there is shown an exemplary data structure of an ACR response which is generated by the ACR response generation block 44 of the ACR server 23.

An ACR response 80 has a data structure indicated by FIG. 9A or 9B. FIG. 9A shows a data structure of the ACR response 80 in the case where the content from which the signature data 74 included in the ACR query 70 has been identified, namely, the content being viewed on the primary screen device 30A has been identified. FIG. 9B shows a data structure of the ACR response 80 in the case where the content has not been identified.

The ACR response 80 (FIG. 9A) in the case where the content being viewed could be identified in the primary screen device 30A includes an ACR query identifier 81, an extraction scheme identifier 82, a service identifier 83, a content identifier 84, ACM information 85, ARM information 86, a reproduction time 87, a local timestamp 88, associated metadata 89, an originator address 90, and a signature 91.

On the other hand, the ACR response 80 (FIG. 9B) in the case where the content being viewed on the primary screen device 30A could not be identified includes an ACR query identifier 81, a service identifier 83, an originator address 90, a signature 91, and an identification fail flag 92.

The ACR query identifier 81, the extraction scheme identifier 82, the service identifier 83, and the local timestamp 88 are used to identify the ACR query 70 which requested the return of the ACR response 80 and are written by quoting the ACR query identification 71, extraction scheme identifier 72, service identifier 73, and local timestamp 75 of the ACR query 70.

The content identifier 84, the ACM information 85, the ARM information 86, the reproduction time 87, and the associated metadata 89 are indicative of content identification results and are written by quoting the content identifier 62, ARM information 66, ACM information 67, reproduction time 63, and associated metadata 64 of the corresponding ACR reference data 60.

The originator address 90 is an address on the bidirectional communication network 12 of the ACR server 23 which transmits this ACR response 80. The signature 91 is used to prevent the tampering of this ACR response 80. It should be noted that the entire ACR response 80 may be encrypted for transmission independently of the copyright of the content, whereby the ACR response 80 can be prevented from being tampered.

The identification fail flag 92 is indicative that the content from which the signature data 74 included in the ACR query 70 from the ACR client 32 was extracted, namely, the content being viewed on the primary screen device 30A could not be identified in the ACR server 23.

### [Operation of the Application-Coordinated System 10]

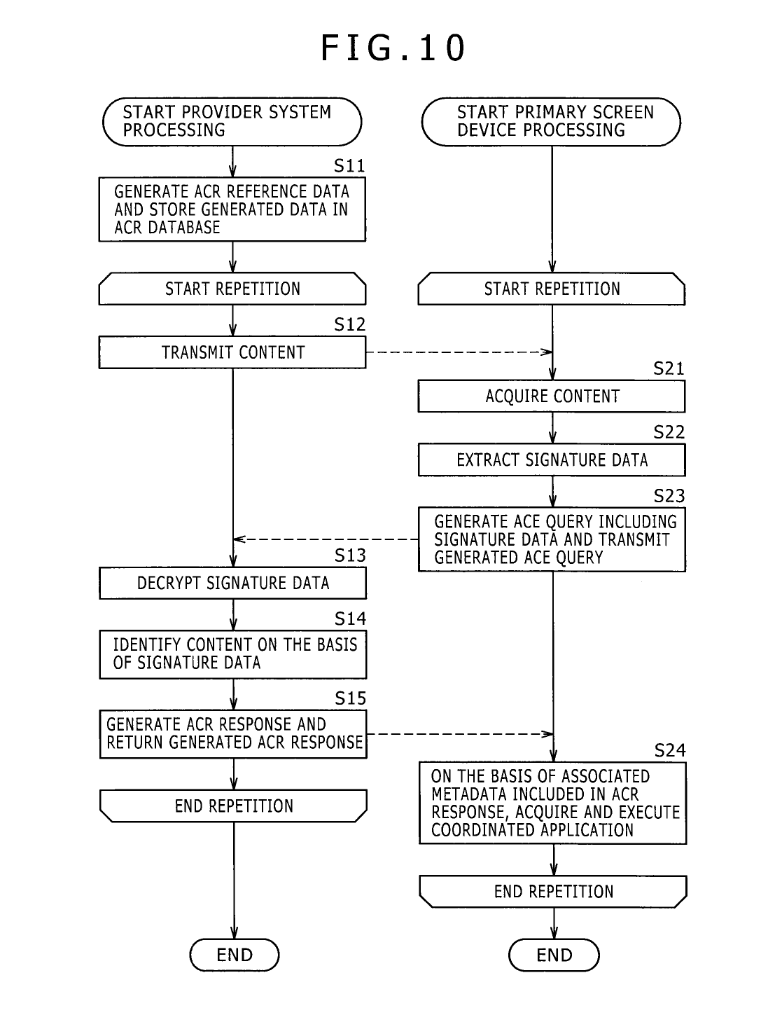

Referring to FIG. 10, there is shown a flowchart indicative of an operation of the application-coordinated system 10.

In the provider system 20, the content to be subsequently broadcast and the associated metadata 64 thereof are supplied to the ACR server 23 in step S11 as the processing to be executed before starting the broadcasting of the content via the broadcasting network 11. The ACR server 23 extracts signature data from the supplied content at a predetermined period, DRM-encrypts the extracted signature data as required, generates the ACR reference data 60 including associated metadata 64, SCM information 65, ARM information 66, and ACM information 67 for each piece of the signature data, and registers the generated ACR reference data 60 in the ACR database block 43.

It should be noted that, in the ACR server 23, it is supposed that the corresponding ACR reference data 60 be generated to be put in a database for not only the content slated to be broadcast but also various kinds of content viewable on the side of the home network system 30. After the ACR reference data 60 corresponding to the various kinds of content has been put in a database as described above, steps S12 through S15 to be described below will be repeated.

In step S12, the content server 21 of the provider system 20 starts broadcasting content via the broadcasting network 11.

On the other hand, in the home network system 30, steps S21 through S24 to be described below will be repeated while content (not limited to the broadcast content) is viewed.

In step S21, the content renderer 31 of the primary screen device 30A acquires and branches the content being viewed and outputs the resultant content to the ACR client 32. In step S22, the ACR client 32 extracts signature data 74 at a predetermined sampling period from the content being viewed which is branched and entered from the content renderer 31.

In step S23, every time signature data 74 is extracted, the ACR client 32 generates an ACR query 70 including this signature data 74 and transmits the generated ACR query 70 to the ACR server 23.

Having received the ACR query 70, the ACR server 23 identifies the content from which the signature data 74 included in the ACR query 70 was extracted.

To be more specific, if signature data 61 of ACR reference data 60 in a database is DRM-encrypted, the ACR database block 43 acquires a key necessary for DRM-decryption from the content server 21 and decrypts the DRM-encrypted signature data 61 in step S13.

In step S14, the ACR response generation block 44 of the ACR server 23 references the ACR database block 43 to identify the content from which the signature data 74 included in the received ACR query 70 was extracted.

In step S15, the ACR response generation block 44 generates an ACR response 80 in accordance with content identification results and returns the generated ACR response 80 to the ACR client 32 from which the ACR query 70 was transmitted.

Having received the ACR response 80, the ACR client 32 analyzes the associated metadata 89 included in the ACR response 80 in step S24 to make the application manager 33 acquire and execute a coordinated application to be executed in coordination with the content being viewed. On the basis of the application identifier included in the associated metadata 89, the application manager 33 acquires the coordinated application from the application server 22 and executes the obtained coordinated application. At this moment, the application manager 33 analyzes the ACM information 85 and the ARM information 86 included in the ACR response 80 to decrypt the DRM-encrypted coordinated application, determine the rendering destination of the coordinated application, execute the coordinated application, and execute quoted content DRM control.

The above-described processing operations of steps S12 through S15 and steps S21 through S24 are repetitively executed while the content is viewed on the side of the home network system 30. Consequently, the operation of a coordinated application in coordination with the progression of the content being viewed is made practicable.

### [About Detail Operations of Coordinated Application Rendering Control and DRM Decryption Processing]

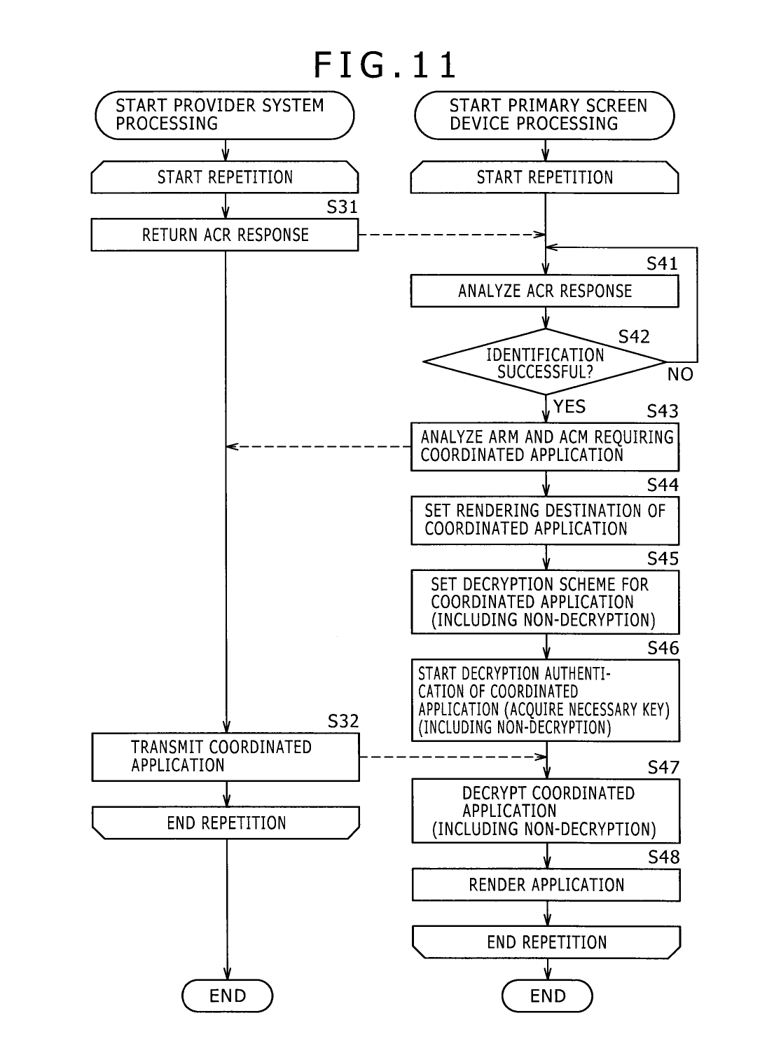

Referring to FIG. 11, there is shown a flowchart indicative of detail operations of coordinated application rendering control and DRM decryption processing which are executed between the ACR server 23 and the application server 22 of the provider system 20 and the ACR client 32 and the application manager 33 of the primary screen device 30A.

The processing operations of steps S31 and S32 of the provider system 20, and the processing operations of steps S41 to S48 of the primary screen device 30A are repetitively executed while content is viewed.

In step S31, the ACR server 23 identifies the content in response to an ACR query 70 received from the ACR client 32 and generates an ACR response 80 in accordance with an identification result, returning the generated ACR response 80 to the ACR client 32.

Having received this ACR response 80, the ACR client 32 analyzes the received ACR response 80 in step S41 and determines whether or not the identification of the content being viewed is successful or not in step S42.

To be more specific, the determination whether or not the identification is successful is executed on the basis of whether or not a identification fail flag 92 is included in the ACR response 80. If the identification fail flag 92 is found to be included in the ACR response 80 and the identification is determined to be failing, then the procedure is returned to step S41. By contrast, if the identification fail flag 92 is found not to be included in the ACR response 80 and therefore the identification is found to be successful, then the procedure goes to step S43. In this case, the data structure of the ACR response 80 is as shown in FIG. 9A, in which the ACM information 85 and the ARM information 86 are included.

In step S43, the ACR client 32 notifies the application manager 33 of the application identifier, the ACM information 85, and the ARM information 86 of a coordinated application included in the associated metadata 89 included in the ACR response 80. On the basis of this application identifier, the application manager 33 accesses the application server 22 to request for the corresponding coordinated application. In addition, the application manager 33 analyzes the ACM information 85 and the ARM information 86.

In step S44, the application manager 33 sets the rendering destination of the coordinated application to be executed in coordination with the content being viewed and yes/no of the superimposed display onto the content on the basis of an analysis result of the ARM information 86. In step S45, on the basis of the ACM information 85, the application manager 33 sets a decryption scheme to be used when the coordinated application to be executed in coordination with the content being viewed is DRM-encrypted (for example, a software module for executing DRM decryption is set beforehand). Further, in step S46, the application manager 33 executes decryption authentication processing to acquire a key which is necessary for the decryption processing if the coordinated application is DRM-encrypted.

On the other hand, in step S32, the application server 22 of the provider system 20 supplies the coordinated application requested by the application manager 33 in the processing of step 43 to the application manager 33 in the DRM-encrypted state (or possibly in the non-encrypted state). In step S47, the application manager 33 decrypts the received DRM-encrypted (or possibly not encrypted) coordinated application in accordance with the decryption scheme defined in the ACM information 85 by use of the key obtained in the processing of step S46.

In step S48, the application manager 33 executes the decrypted coordinated application and, at the same time, controls the rendering by the coordinated application on the basis of the setting done in the processing of step S44.

The processing operations described above allow the rendering and DRM control of a coordinated application with the intentions of the respective copyright owners of the coordinated application and the content reflected.

As described above, in the present embodiment, the copyright information on the signature data extracted from content is defined as SCM information 65, so that the practice of any unauthorized ACR services not permitted by content copyright owners may be prevented.

In addition, the configuration in which ARM information 66 for operation control information for a coordinated application to be executed in coordination with the progression of content may be set by the copyright owner of this content allows the execution of the operation of a coordinated application with the rights and intentions of both the copyright owners of the content and the coordinated application reflected. Consequently, the copyright owner of content may prevent the execution of a coordinated application which may infringe the copyright thereof. On the other hand, the copyright owner of a coordinated application may prevent the rendering to a device not intended by the copyright owner.

Further, in the present embodiment, ACM information 67 for the copyright protection for a coordinated application and the quoted content quoted thereby is defined, so that the unauthorized copy and the like of coordinated applications and the quoted content thereof may be prevented.

It should be noted that the provider system 20 and the primary screen device 30A for executing the above-described sequence of processing operations may be not only configured each by hardware but also realized by executing software through a computer. This computer includes a computer incorporated in a dedicated hardware and a general-purpose personal computer which executes various kinds of functions by installing various kinds of programs, for example.

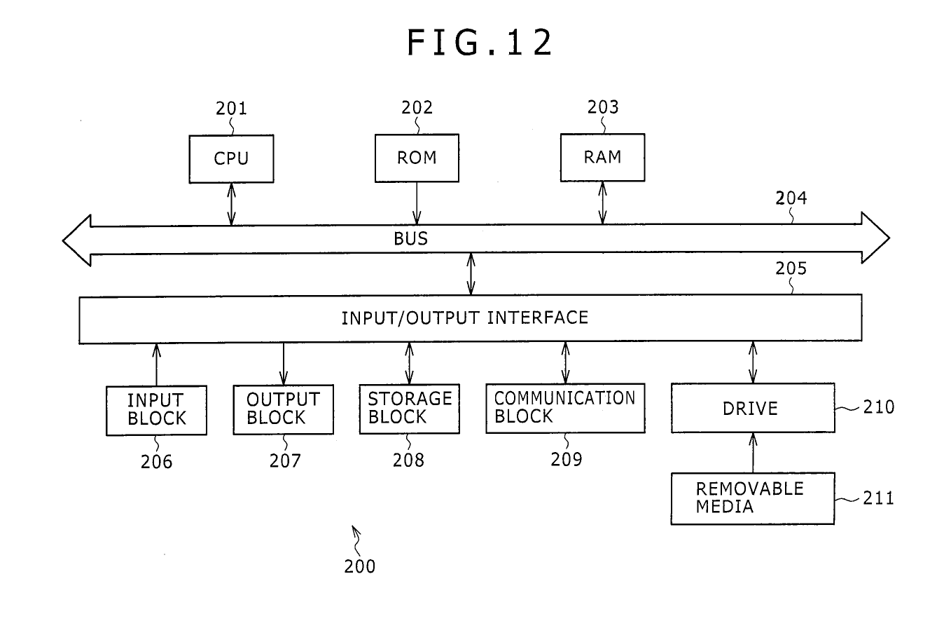

Referring to FIG. 12, there is shown an exemplary hardware configuration of the above-mentioned computer.

In the computer 200, a CPU (Central Processing Unit) 201, a ROM (Read Only Memory) 202, and a RAM (Random Access Memory) 203 are interconnected by a bus 204.

The bus 204 is further connected with an input/output interface 205. The input/output interface 205 is connected with an input block 206, and output block 207, a storage block 208, a communication block 209, and a drive 210.

The input block 206 is made up of a keyboard, a mouse, and a microphone, for example. The output block 207 is made up of a display and a speaker, for example. The storage block 208 is made up of a hard disk or a nonvolatile memory, for example. The communication block 209 is made up of a network interface for example. The drive 210 drives a removable media 211 such as a magnetic disk, an optical disk, a magnet-optical disk or a semiconductor memory, for example.

In the computer 200 configured as described above, the above-mentioned sequence of processing operations are executed when the CPU 201 loads a program from the storage block 208 for example into the RAM 203 through the input/output interface 205 and the bus 204 and executes the loaded program in the computer 200.

Programs to be executed by the computer 200 (or the CPU 201) may be recorded to the removable media 211 which is a package media and provided therein. In addition, programs may be provided through wired or wireless transmission media, such as a local area network, the Internet, and digital satellite broadcasting.

In the computer 200, loading the removable media 211 on the drive 210 installs programs into the storage block 208 through the input/output interface 205. In addition, programs may be received at the communication block 209 through wired or wireless transmission media to be installed in the storage block 208. Alternatively, programs may be installed in the ROM 202 or the storage block 208 in advance.

It should be noted that the programs to be executed by the computer 900 may be the program executed in a time-dependent manner in the sequences described herein or executed in parallel or on an on-demand basis when it called.

It is to be noted that embodiments of the present disclosure are not limited to the foregoing embodiments, and that various changes can be made without departing from the spirit of the present disclosure.

What is claimed is:

1. An information processing apparatus comprising:
a content management block configured to manage first content which may be viewed on a content reproduction apparatus side for reproducing content;
a database block configured to generate reference data by relating, with first signature data indicative of a feature of said first content extracted therefrom, rights management information about said first signature data and a content identifier indicative of said first content from which said first signature data was extracted and put said generated reference data into a database; and
an identification block configured, in response to a query which is transmitted from said content reproduction apparatus side and is including second signature data indicative of a feature of second content extracted from said second content being viewed by a user of said content reproduction apparatus, to identify said content by referencing said reference data stored in said database block, thereby returning a response indicative of a result of the identification.

2. The information processing apparatus according to claim 1, wherein
said first signature data of said reference data is encrypted, and
said database block decrypts said encrypted first signature data after authentication with said content management block.

3. The information processing apparatus according to claim 2, wherein said rights management information associated with said first signature data includes an item for selecting an existing rights management scheme for said first signature data.

4. The information processing apparatus according to claim 3, wherein said rights management information associated with said first signature data further includes an item for setting, as desired, a rights management scheme for said first signature data.

5. An information processing method for an information processing apparatus, comprising:
causing said information processing apparatus to generate reference data by relating, with first signature data indicative of a feature of first content extracted from said first content which may be viewed on a content reproduction apparatus side for reproducing content, rights management information about said first signature data and a content identifier indicative of said first content from which said first signature data was extracted, and put said generated reference data into a database; and
causing said information processing apparatus to identify said content by referencing said reference data stored in said database in response to a query which is transmitted from said content reproduction apparatus side and is including second signature data indicative of a feature of second content extracted from said second content being viewed by a user of said content reproduction apparatus, thereby returning a response indicative of a result of the identification.

6. An information processing apparatus comprising:
a content management block configured to manage first content which may be viewed on a content reproduction apparatus side for reproducing content;
a database block configured to generate reference data by relating, with first signature data indicative of a feature of said first content extracted from said first content, a content identifier indicative of said first content from which said signature data was extracted, an application identifier indicative of an application to be executed on said content reproduction apparatus side in coordination with the progression of said first content if said first content is being viewed on said content reproduction apparatus side, and rendering control information for controlling rendering of said application, and put said generated reference data into a database; and
an identification block configured, in response to a query which is transmitted from said content reproduction apparatus side and is including second signature data indicative of a feature of second content extracted from said second content being viewed by a user of said content reproduction apparatus, to identify said content by referencing said reference data stored in said database block, thereby returning a response indicative of a result of the identification.

7. The information processing apparatus according to claim 6, wherein said rendering control information includes at least one of an item for limiting a device to which a video created by said application is outputted and an item for limiting superimposed display of the video created by said application and a video of said content.

8. An information processing method for an information processing apparatus, comprising:
causing said information processing apparatus to generate reference data by relating, with first signature data indicative of a feature of a first content extracted from said first content which may be viewed on a content reproduction apparatus side for reproducing content, a content identifier indicative of said first content from which said signature data was extracted, an application identifier indicative of an application to be executed on said content reproduction apparatus said in coordination with the progression of said first content if said first content is being viewed on said content reproduction apparatus, and rendering control information for controlling rendering of said application, and put said generated reference data into a database; and
causing said information processing apparatus to identify said content by referencing said reference data stored in said database in response to a query which is transmitted from said content reproduction apparatus side and is including second signature data indicative of a feature of second content extracted from said second content being viewed by a user of said content reproduction apparatus, thereby returning a response indicative of a result of the identification.

9. An information processing apparatus comprising:
a query generation block configured to extract signature data indicative of a feature of content being reproduced, generate a query including said signature data, transmit said generated query to an identification server, and receive a response returned from said identification server in accordance with said query; and
an application execution block configured to acquire an application specified to be executed in coordination with the progression of said content being reproduced on the basis of an application identifier included in said received response, execute said acquired application, and, on the basis of rendering control information of said acquired application included in said response, control the rendering of said acquired application.

10. The information processing apparatus according to claim 9, wherein, on the basis of said rendering control information, said application execution block executes at least one of processing for limiting a device to which a video created by said application is outputted and processing for limiting superimposed display of a video created by said application and a video of said content.

11. An information processing method for an information processing apparatus, comprising:
causing said information processing apparatus to extract signature data indicative of a feature of content being reproduced, generate a query including said signature data, and transmit said generated query to an identification server;
causing said information processing apparatus to receive a response returned from said identification server in accordance with said query; and
causing said information processing apparatus to acquire an application specified to be executed in coordination with the progression of said content being reproduced on the basis of an application identifier included in said received response, execute said acquired application, and, on the basis of rendering information of said acquired application included in said response, control the rendering of said acquired application.

12. An information processing apparatus comprising:
a content management block configured to manage first content which may be viewed on a content reproduction apparatus;
a database block configured to generate reference data by relating, with first signature data indicative of a feature of said first content extracted from said first content, a content identifier indicative of said first content from which said first signature data was extracted, an application identifier indicative of an application to be executed on said content reproduction apparatus side in coordination with the progression of said first content if said first content is being viewed on said content reproduction apparatus side, and rights management information about said application, and put said generated reference data into a database; and
an identification block configured, in response to a query which is transmitted from said content reproduction apparatus side and is including second signature data indicative of a feature of second content extracted from said second content being viewed by a user of said content reproduction apparatus, to identify said content by referencing said reference data stored in said database block, thereby returning a response indicative of a result of the identification.

13. The information processing apparatus according to claim 12, wherein said rights management information about said application includes an item for selecting an existing rights management scheme for said application and a quoted content to be quoted by said application.

14. The information processing apparatus according to claim 13, wherein said rights management information about said application further includes an item for setting, as desired, a rights management scheme for said application and quoted content to be quoted by said application.

15. An information processing method for an information processing apparatus, comprising:
causing said information processing apparatus to generate reference data by relating, with first signature data indicative of a feature of first content extracted from said first content which may be viewed on a content reproduction apparatus side for reproducing content, a content identifier indicative of said first content from which said first signature data was extracted, an application identifier indicative of an application to be executed on a content reproduction apparatus side in coordination with the progression of said first content if said first content is being viewed on said content reproduction apparatus side, and rights management information about said application, and put said generated reference data into a database; and
causing said information processing apparatus to identify said content by referencing said reference data stored in said database in response to a query which is transmitted from said content reproduction apparatus side and is including second signature data indicative of a feature of second content extracted from said second content being viewed by a user of said content reproduction apparatus, thereby returning a response indicative of a result of the identification.

16. An information processing apparatus comprising:
a query generation block configured to extract signature data indicative of a feature of content being reproduced, generate a query including said signature data, transmit said query to an identification server, and receive a response returned from said identification server in accordance with said query; and
an application execution block configured to acquire an application specified to be executed in coordination with the progression of said content being reproduced on the basis of an application identifier included in said received response, execute said acquired application, and, on the basis of rights management information of said application included in said response, manage said application and quoted content to be quoted by said application.

17. The information processing apparatus according to claim 16, wherein said application execution block decrypts said encrypted application on the basis of said rights management information.

18. The information processing apparatus according to claim 16, wherein said application execution block manages copy processing for said application and said quoted content on the basis of said rights management information.

19. An information processing method for an information processing apparatus, comprising:
causing said information processing apparatus to extract signature data indicative of a feature of content being reproduced, generate a query including said signature data, and transmit said query to an identification server;
causing said information processing apparatus to receive a response returned from said identification server in accordance with said query; and
causing said information processing apparatus to acquire an application specified to be executed in coordination with the progression of said content being reproduced on the basis of an application identifier included in said received response, execute said acquired application, and, on the basis of rights management information of said application included in said response, manage said application and quoted content to be quoted by said application.
